(19) United States
(12) Patent Application Publication
(10) Pub. No.: US 2022/0021278 A1
(43) Pub. Date: Jan. 20, 2022

(54) INTEGRATED ENCODER AND RESOLVER

(71) Applicant: Genesis Robotics and Motion Technologies, LP, Wichita, KS (US)

(72) Inventor: James Brent Klassen, Surrey (CA)

(73) Assignee: Genesis Robotics and Motion Technologies, LP, Wichita, KS (US)

(21) Appl. No.: 17/294,707

(22) PCT Filed: Nov. 20, 2019
(86) PCT No.: PCT/IB2019/059961

§ 371 Date: May 18, 2021

Related U.S. Application Data
(60) Provisional application No. 62/769,587, filed on Nov. 20, 2018.

(51) Int. Cl. H02K 11/225; H02K 11/24; G01D 5/20

(52) U.S. Cl. CPC H02K 11/225; G01D 5/202; H02K 11/24

(57) ABSTRACT

The present disclosure provides position detector for an electric machine. The detector uses one or more proximity sensors, such as eddy current sensors, to detect features on the rotor of an electric machine. The detectable feature may be a spiral groove, which has a unique position at any given point around the circumference of the rotor. As the rotor is typically steel, the proximity sensors produce different output values depending on the degree to which they are aligned with the groove. As such, given that the groove has a unique position at any given location, the output of the proximity sensors is also unique for any given position. This enables the position of the rotor with respect to the sensors to be determined.

### RELATED APPLICATIONS

This application claims priority to U.S. Provisional Application Ser. No. 62/769,587 filed Nov. 20, 2018, which application is incorporated herein by reference in its entirety.

### FIELD OF THE DISCLOSURE

The present disclosure relates to electric machines. Specifically, the present disclosure relates to devices for determining the relative and absolute position of a rotor with respect to a stator, or vice versa.

### BACKGROUND

Electric machines, such as motors, typically comprise a stator and a rotor which rotate with respect to each other. The rotor typically comprises a number of permanent magnets, and the stator typically comprises a corresponding number of electromagnets. In use, magnetic coupling is created between the permanent magnets and the electromagnets. By modifying an electric current entering the electromagnets, the magnetic field between the rotor and the stator can be varied. This change in magnetic field may cause the rotor to rotate with respect to the stator, creating a mechanical output. In such circumstances, the electric machine can be considered as a motor. By physically rotating the rotor relative to the stator, the magnetic field can be caused to fluctuate to induce an electric current in the stator. Therefore, a physical input can be used to generate an electrical output. In such circumstances, the electric machine can be considered as a generator.

PCT Patent Application Publication No. WO2017024409 discloses a high pole-count radial electric machine which produces a significantly better torque-to-weight ratio than other prior art electric machines. The electric machine generally comprises a cylindrical rotor which comprises a large number of permanent magnets (typically 50 or more), distributed around its circumference. The magnets are arranged in an alternating fashion with a number of radially extending posts. The magnets are retained in slots formed in the rotor between adjacent posts. The stator is then typically formed around the outer circumference of the rotor, such that an airgap is formed between the stator and the rotor. The stator includes current-carrying coils, arranged around the diameter of the stator. In use, magnetic flux-paths are formed between the permanent magnets of the rotor and the coils of the stator.

In many applications, it can be very useful to monitor relative positioning between a rotor and a stator. For example, when using an electric machine as an actuator in, say, a robotic device, it is important to know how two components coupled by the actuator are oriented with respect to each other. Due to the complexities involved with designing electric machines, as outlined above, monitoring such positioning can be difficult to achieve. The small amounts of space located within an electric machine, the strong, fluctuating magnetic fields and the careful calibration required all contribute to the complexity involved in monitoring the positioning of an electric machine.

### SUMMARY OF THE DISCLOSURE

The present disclosure provides position detector for an electric machine. The detector uses one or more proximity sensors, such as eddy current sensors, to detect features on the rotor of an electric machine. The detectable feature may be a spiral groove, which has a unique position at any given point around the circumference of the rotor. As the rotor is typically steel, the proximity sensors produce different output values depending on the degree to which they are aligned with the groove. As such, given that the groove has a unique position at any given location, the output of the proximity sensors is also unique for any given position. This enables the position of the rotor with respect to the sensors to be determined.

In a first aspect, the present disclosure provides an electric machine, comprising: a first carrier having a detectable feature, the detectable feature having a length which extends across the first carrier; a second carrier, positioned adjacent to the first carrier; and one or more proximity sensors coupled to the second carrier, the one or more sensors being arranged to detect the detectable feature and to output a signal which is unique for each of a plurality of positions along the length of the detectable feature.

In a second aspect, the present disclosure provides an electric machine, comprising: a first carrier having a detectable feature, the detectable feature having a plurality of first regions and a plurality of second regions, the first and second regions configured in an alternating arrangement; a second carrier, positioned adjacent to the first carrier; and one or more proximity sensors coupled to the second carrier, the one or more proximity sensors being arranged to produce an output signal, the output signal having a first range of values, when proximate the first regions, and a second range of values when proximate the second regions; wherein movement of the first carrier with respect to the second carrier causes the output signal to vary between the first and second ranges of values.

In a third aspect, the present disclosure provides system for detecting movement or position of an electric machine, the system including: an electric machine as defined in the first or second aspects; a processor, coupled to the one or more proximity sensors, and arranged to process the signals output by the one or more proximity sensors.

In a fourth aspect, the present disclosure provides method of detecting a position of a carrier of an electric machine, the electric machine having a first carrier having a detectable feature, the detectable feature having a length which extends across the first carrier, the method comprising: using one or more proximity sensors coupled to a second carrier, positioned adjacent to the first carrier, detecting the detectable feature and outputting a signal which is unique for each of a plurality of positions along the length of the detectable feature; and determining, based on the output signal, a position of the first carrier with respect to the second carrier.

In a fifth aspect, the present disclosure provides method of detecting movement of a carrier of an electric machine, the electric machine having a first carrier having a detectable feature, the detectable feature having a plurality of first regions and a plurality of second regions, the first and second regions configured in an alternating arrangement; the method comprising: using one or more sensors coupled to a second carrier, positioned adjacent to the first carrier, outputting a signal having a first range of values, when proximate the first regions, and a second range of values when proximate the second regions; and moving the first carrier with respect to the second carrier, such that the output signal to varies between the first and second range of values.

In a sixth aspect, the present disclosure provides method for calibrating an electric machine according to the first aspect, comprising: positioning the first carrier in a first predetermined position with respect to the second carrier; recording, in a memory, the output of the one or more sensors in the first predetermined position; moving the first carrier, with respect to the second carrier, through a plurality of further predetermined positions; recording, in the memory, in each further predetermined position, the output of the one or more sensors.

In a seventh aspect, the present disclosure provides a position detector for an axial or radial electric machine, comprising: one or more proximity sensors, positioned in one of a stator or rotor of an electric machine; a detectable feature, arranged circumferentially around the other of the stator or rotor, the feature detectable by the one or more proximity sensors; wherein the detectable feature is configured such that at each circumferential position of the rotor, with respect to the stator, the detectable feature produces a unique output in the one or more proximity detectors.

In an eighth aspect, the present disclosure provides encoder for an electric machine, comprising: at least one proximity sensor, located on a stator; a rotor, comprising a detectable feature, comprising first and second regions arranged in an alternating configuration, each region causing the sensor to produce a different output; a processor, arranged to process the output of the sensor to determine the speed and/or degree of movement of the rotor with respect to the stator.

Further features of the disclosure are described below and defined in the appended claims.

### BRIEF DESCRIPTION OF THE DRAWINGS

The present disclosure will now be described by way of example only and with reference to the accompanying drawings, in which:

FIG. 1 shows a schematic cross-sectional view of an electric machine in accordance with the prior art;

FIG. 2 shows a rotor for use with a radial or an axial electric machine in accordance with the prior art;

FIG. 3 shows an encoder for an axial electric machine in accordance with the present disclosure;

FIG. 4 shows a resolver for an axial electric machine in accordance with the present disclosure;

FIG. 5 shows an encoder for a radial electric machine in accordance with the present disclosure;

FIG. 6A shows a resolver for a radial electric machine in accordance with the present disclosure;

FIG. 6B shows a typical eddy current signal for the eddy current sensors of the resolver of FIG. 6A;

FIG. 7 shows a resolver for a radial electric machine in accordance with the present disclosure;

FIG. 8 shows a typical eddy current signal for the resolver of FIG. 6;

FIG. 9 shows an eddy current coil for use with the present disclosure;

FIG. 10 shows a resolver according to FIG. 6 using a single sensor;

FIG. 11 shows a method of calibrating a resolver according to the present disclosure;

FIG. 12 shows a method of determining an absolute position of a rotor with respect to a stator in accordance with the present disclosure; and

FIG. 13 shows a schematic of a system according to the present disclosure.

### DETAILED DESCRIPTION OF THE DISCLOSURE

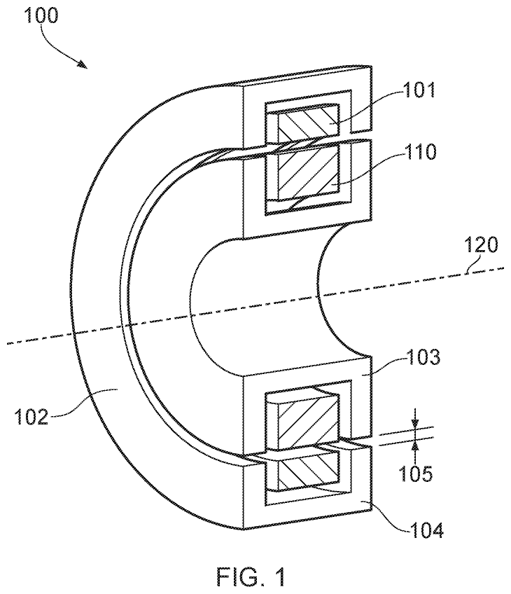

The present disclosure relates to turn counters and position sensors for electric machines. The applicant designs and builds high pole count electric machines for which the presently described embodiments are particularly well suited. The electric machines developed by the applicant have been described above in the background section but will be discussed here with reference to FIG. 1.

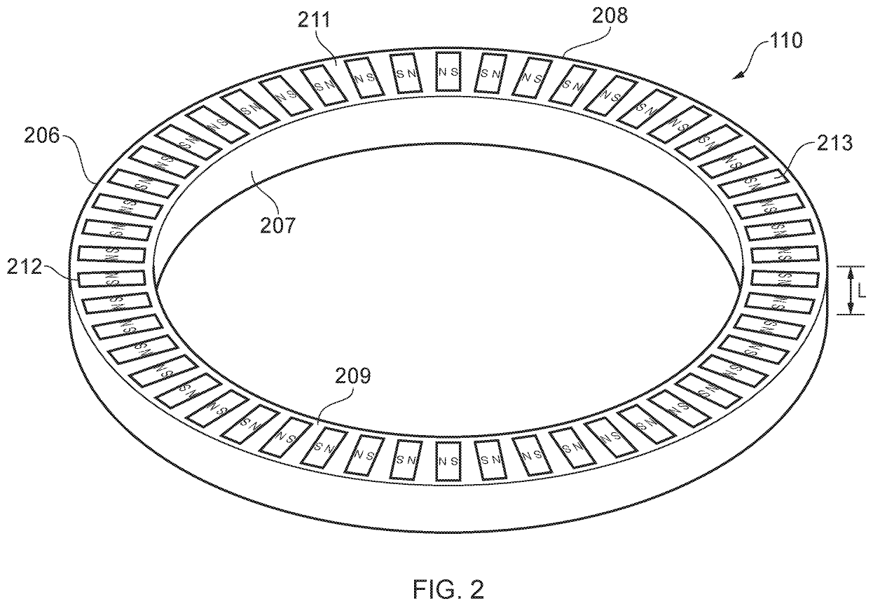

FIG. 1 is a schematic cross-sectional view of a prior art electric machine 100. The electric machine 100 comprises a rotor 110 and a stator 101 extending around the outer circumference of the rotor 110. The rotor 110 is rotatable about a rotor axis 120 relative to the stator 101. The stator 101 comprises a plurality of windings (not shown) which each generate an associated electromagnetic field which varies in response to an electric current passing through the windings. The rotor 110 includes a number of magnets which are magnetically coupled to the windings of the stator 101 during use and are located within magnet retaining slots in the rotor 110, as discussed in more detail below in relation to FIG. 2. The rotor 110 and the stator 101 are positioned such that an air gap 105 exists between the two components. This airgap 105 is typically sized such that the rotor 110 and the stator 101 are as close as possible to each other, without physically touching. This is intended to maximise the magnetic coupling between the magnets of the rotor 110 and the windings of the stator 101 without incurring frictional losses. The electric machine 100 also comprises a housing within which the rotor 110 and the stator 101 are at least partly housed. In this example, the housing comprises a first housing 103 and a second housing 104 extending around the first housing 103. The first housing 103 is rotatable relative to the second housing 104 about the rotor axis 120. The first housing 103 is fixed for rotation with the rotor 110 and the second housing 104 is fixed for rotation with the stator 101. In this example, drive may be transferred to and/or from the electric machine 100 by fixation points (not shown) on the first and second housings 103, 104. In other examples, drive may transferred to and/or from the electric machine 100 via a drive shaft fixed to the rotor 110. In such examples, the housing may be a single piece housing.

While the electric machine 100 is illustrated in FIG. 1 as a radial electric machine in which the windings of the stator 101 are located around the outer circumference of the rotor 110, in alternative embodiments, the stator 101 may be located radially inside the rotor 110. In further embodiments, the electric machine 100 may be an axial electric machine in which the rotor 110 and the stator 101 are located axially adjacent each other.

FIG. 2 is a perspective view of a known rotor 110 for the electric machine 100 of FIG. 1. The rotor 110 comprises a rotor body 206, which forms the main structural part of the rotor 110. The rotor body 206 is generally annular and cylindrical in shape and extends in the axial direction along a length L from its first axial end to its second axial end. The rotor body 206 has an inner circumference defining an inner diameter 207 and an outer circumference defining an outer diameter 208. The inner circumference is defined by a back-iron 209. The rotor body 206 further includes an array of rotor posts 211 extending radially from the back-iron 209 towards the outer circumference. The posts 211 are spaced apart in the circumferential direction to define an array of magnet-retaining rotor slots 212 which are also spaced apart in the circumferential direction and alternate with the rotor posts 211 in the circumferential direction. The rotor slots 212 are defined by voids in the rotor body 206 between adjacent posts 211. In this example, the rotor posts 211 and the rotor slots 212 extend in the axial direction along the entire length L of the rotor body. In other examples, the rotor posts 211 and/or the rotor slots 212 may extend along only part of the length L of the rotor body 206.

The rotor body 206 may be formed from a plurality of layers, or laminate sheets, which are stacked together, for example in the axial direction. Alternatively, the rotor body 206 may be formed from a single piece of material. The rotor body 206 may be made from any suitable material, including but not limited to steel, iron, a steel alloy such as a cobalt alloy or nickel alloy, a cobalt iron powder, or other soft magnetic material. In certain embodiments, the rotor body 206 is made from steel, which has high magnetic susceptibility so as to enable the flow of magnetic flux and is sufficiently stiff to resist deformation by the torque generated by the electric machine 100. The slots 212 may be defined by stamping, if the rotor body 206 is formed from laminate sheets. Alternatively, the slots 212 may be formed by machining to remove material from between the posts 211, for example using electrical discharge machining (EDM), or may be formed at the same time as the posts 211, for example by casting or using an additive manufacturing process to form the rotor body 206.

The rotor 110 also comprises a plurality of magnets 213, which are inserted and secured within the rotor slots 212. The magnets 213 are inserted in the rotor slots 212 such that they are circumferentially polarised, with the north pole N of each magnet 213 facing toward the north pole N of an adjacent magnet 213 and the south pole S of each magnet 213 facing toward the south pole S of an adjacent magnet 213. In this manner, the rotor 110 comprises an even number of rotor posts 211, rotor slots 212 and magnets 213. Owing to the arrangement of the magnets 213, magnetic flux at a pole of one magnet 213 is forced towards the edges of the rotor 110 by the adjacent magnet 213 having an identical pole, also facing that magnet 213. Ideally, this flux should be directed across the airgap 105 towards the stator 101 at the outer circumference of the rotor 110. With this arrangement, the posts 211 amplify the magnetic flux from the magnets 213 and direct it toward the outer circumference of the rotor 110 which, in a radial electric machine, is adjacent a stator 101. By amplifying the magnetic flux of the magnets 213 and minimising magnetic flux leakage elsewhere in the rotor 110, the efficiency and/or torque of a corresponding electric machine 100 can be increased.

As noted above, it is useful to be able to determine, at any point in time, the relative position of the rotor 110 with respect to the stator 101. However, accurately determining the relative position is made difficult due to the small amount of space available within the electric machine 100, and the strong magnetic fields at play between the rotor 110 and the stator 101.

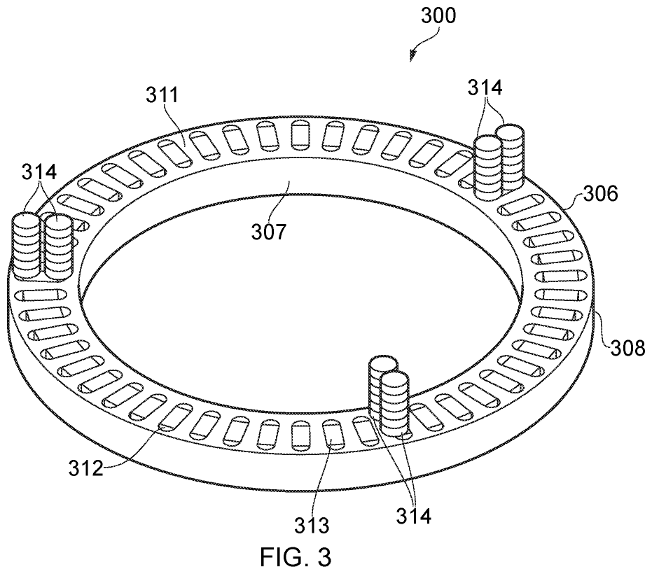

With reference to FIG. 3, there is shown a perspective view of certain parts of an axial electric machine, including an axial encoder 300, in accordance with the present disclosure. The term ‘encoder’ is used in the art to refer to a device which is capable of monitoring relative movement between a rotor and a stator. Although FIG. 3 shows an axial electric machine, rather than a radial electric machine, certain elements are the same as shown in FIG. 2. The electric machine shown in FIG. 3 includes a rotor body 306 which comprises a plurality of magnet-retaining rotor slots 312. A plurality of magnets 313 are located within respective rotor slots 311. The rotor slots 312, and hence the magnets 313, are evenly spaced around the circumference of the rotor body 306. Rotor posts 311 are positioned between each rotor slot 312. The rotor posts 311, rotor slots 312 and the magnets 313 extend between an inner diameter 307 and an outer diameter 308 of the rotor body 306.

The axial encoder 300 of FIG. 3 comprises a plurality of eddy current sensors 314. Although not shown in FIG. 3, the eddy current sensors 314 are attached to a stator of the electric machine. The stator is omitted for clarity. The eddy current sensors 314 are configured to detect the rotor body 306 by inducing eddy currents within it. In this manner, as the rotor body 306 rotates with respect to the stator, the magnets 313 and the rotor posts 311 move past the eddy current sensors 314. As such, the distances between the rotor body 306 and the eddy current sensors 314 varies over time. This can be regarded as a detectable feature of the rotor body 306. Due to the manner in which the magnets 313 and the rotor posts 311 are positioned around the rotor body 306, the eddy currents detected by each eddy current sensor 314 results in a sinusoidal output, as the rotor is rotated with respect to the stator. In this regard, when a rotor post 311 is aligned with an eddy current sensor 314, the eddy current sensor output is at a maximum. Similarly, when a magnet 313 is aligned with the eddy current sensor 314, the eddy current sensor output is at a minimum. This is because eddy currents are generated in the steel of the rotor posts 311. By coupling the eddy current sensors 314 with an appropriate processor, it is then possible to determine, by monitoring the number of maxima and minima in the eddy currents detected by one or each sensor 314, relative motion between the rotor body 306 and the stator.

FIG. 3 shows that the axial encoder 300 comprises six eddy current sensors 314, arranged in three pairs. However, it should be understood that the axial encoder 300 may comprise any number of sensors 314. For example, the axial encoder may comprise one, two, three, four, five or more sensors 314. If using only one sensor 314, it is possible to monitor variations in eddy currents, as set out above, and determine movement, speed of rotation, and the number of turns of the rotor. However, by using more than one sensor 314, a more accurate determination of the relative motion of the rotor body 306 and the stator may be made, as described below. As such, one may use multiple sensors 314.

Specifically, by using multiple eddy current sensors 314, redundancy and accuracy is increased. By using multiple sensors. Moreover, if using one sensor, when that sensor is at a peak on the sinusoidal wave, small movements of the rotor may not be detectable, and the direction of rotation may not be resolvable. As such, by using two or more sensors, it is possible to ensure that at least one of the sensors is always producing an output which is on a stepper part of the sinusoidal wave slope. This increases the resolution that is achievable by the sensor. Arranging the sensors such that they produce readings on different parts of the sinusoidal wave can be achieved in one of two ways, as will be described below.

First, using the example of FIG. 3 in which the encoder 300 comprises three pairs of sensors 314, the sensors 314 can be positioned such that they are circumferentially spaced apart at 120° intervals. To ensure that the three pairs of sensors are not detecting the same portion of the sinusoidal eddy current signal, the number of magnets 313 (and consequently, the number of rotor posts 311 and rotor slots 312) should be a number which is not divisible by three. In this manner, each pair of eddy current sensors is aligned with a slightly different aspect of the alternating magnet/post arrangement. For example, while one pair is aligned with a post, and thus producing a minimum output, another may be aligned with the edge of a rotor slot, thus producing a point on the sinusoidal slope. As long as the number of magnets 313 in the rotor body 306 is not divisible by the number of circumferential positions of the eddy current sensors 314, the sensors 314 may be positioned equidistantly about the circumference of the rotor body 306.

Second, still using the example of FIG. 3 in which the encoder 300 comprises three pairs of sensors 314, rather than spacing the eddy current sensors 314 at 120° intervals around the rotor body 306, they may be offset from 120°. In this manner, the number of magnets 313 may be divisible by the number of circumferential positions of the eddy current sensors 314. For example, a first pair of sensors 314 may be positioned at 0°, a second pair of sensors 314 may be positioned at 67° around the circumference and a third pair of sensors 314 may be positioned at 153° around the circumference. In this manner, each pair of sensors will be aligned with a different respective portion of the magnet/post arrangement. Of course, in practice, the specific positions of each of the eddy current sensors will vary based on the number of rotor posts 311, as this directly effects the positions at which the eddy current sensors 314 will output signals which are in phase.

The eddy current sensors 314 of the FIG. 3 are arranged in pairs in order to further improve the accuracy of the encoder 300 and to introduce redundancy. In this manner, the eddy current sensors are radially aligned such that the rotor posts 311 align with both sensors 314 of the pair at the same time. Therefore, the signals output by paired sensors should always be in phase and enable more accurate information regarding the movement of the rotor to be provided.

Due to the relatively simple construction of modern eddy current sensors 314, it is possible to locate them between the windings of the stator and a front iron of the rotor body 306, located at the outer diameter 308 (for an inner rotor electric machine).

One would expect that, due to the intense magnetic coupling between a rotor and a stator, within an electric machine, it would be difficult for an eddy current sensor 314 to be used. However, as eddy current sensors 314 have a relatively high inductance, they are able to ignore the low frequency magnetic field variations occurring between the rotor and the stator when operated at frequency which is higher than that which the stator coils are operated at. The ability of eddy current sensors 314 to detect high frequency oscillations in eddy currents can be further improved by introducing a high pass filter, which removes any low frequency variations in the signal.

It should be further noted that, using the relative position information determined by the eddy current sensors 314, it is also possible to determine an absolute position of the rotor body 306 with respect to a stator. In order to achieve this, a processor which is receiving the eddy current signals and, thus, determining the relative position information further requires position information regarding an original orientation of the rotor body 306 with respect to the stator. With this information, it is therefore possible to apply the relative position information to the initial absolute position information to determine a present absolute position.

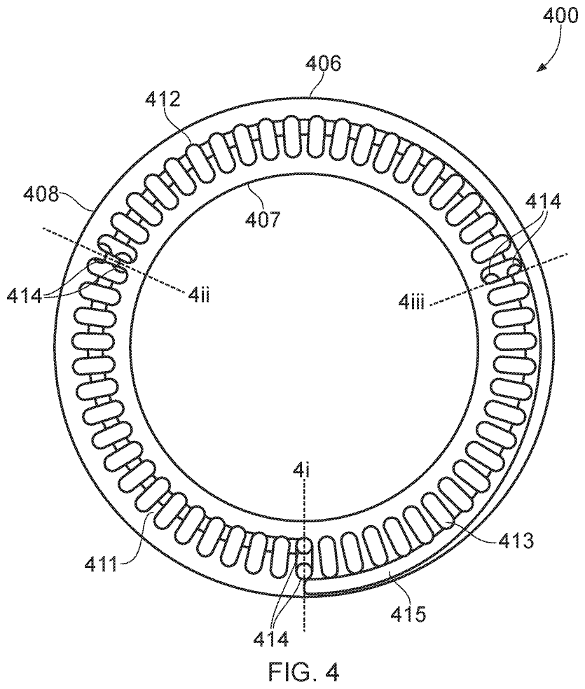

Referring now to FIG. 4, there is shown a plan view of certain parts of an axial electric machine, including an axial resolver 400, in accordance with the present disclosure. The term resolver is used in the art to refer to a device which is capable of determining the absolute position of one of a rotor or a stator with respect to the other. Resolvers use similar principles to encoders, such as the encoder 300 above. However, an encoder may not be capable of determining the absolute position of the rotor and the stator relative to each other in as simple and accurate a manner as a resolver.

The electric machine shown in FIG. 4 includes a rotor body 406 which comprises a plurality of magnet-retaining rotor slots 412. A plurality of magnets 413 are located within respective rotor slots. The rotor slots 412 and, hence the magnets 413, are evenly spaced around the circumference of the rotor body 406. Rotor posts 411 are formed between the rotor slots 412. The rotor posts 411, rotor slots 412 and the magnets 413 extend between an inner diameter 407 and an outer diameter 408 of the rotor body 406. Further, the resolver 400 also comprises a plurality of eddy current sensors 414, which are attached to a stator (not shown). As with the encoder 300, the resolver 400 may comprise any number of eddy currents sensors 414, including one, two, three, four, five, six or more sensors 414. However, higher numbers of sensors 414 may be used in order to provide for a higher ‘resolution’ of determined position.

In contrast to the axial encoder 300 of FIG. 3, the axial resolver 400 of FIG. 4 further comprises a groove 415 which is formed into a surface of the rotor body 406. The groove 415 is formed such that, at one end, the groove 415 is formed adjacent the outer diameter 408 of the rotor body 406 and, at the other end, such that it is adjacent the inner diameter 407 of the rotor body 406. In this manner, the groove 415 forms a type of spiral which curves from the outer diameter 408 to the inner diameter 407 as it curves around a circumference of the rotor body 406. The groove 415 is, importantly, only formed in the rotor body 406 itself, and no material is removed from the magnets 413, where the groove 415 crosses the magnets 413. In this manner, the resolver 400 does not act to reduce the magnetic coupling between the rotor and the stator of the electric machine to which it is a part. In combination with the alternating nature of the rotor posts 411 and the magnets 413, the groove 415 is a further detectable feature, which acts to make the alternating eddy current signal unique, in terms of its amplitude, at any given point around the circumferential extent of the rotor body 406.

When an eddy current sensor is aligned with a post, the sensor signal strength will be lower when radially aligned with the groove 415. This is because the material of the post is positioned further away from the sensor, thereby causing the sensor to produce a weaker signal. As such, an amplitude of the signal output by the eddy current sensors 414 varies, in comparison to an equivalent signal from an eddy current sensor 314 of the axial encoder 300 of FIG. 3, depending on whether or not the sensor is aligned with the groove. Due to the spiral nature of the groove 415, the signal output by each eddy current sensor 414 varies in amplitude around the circumference of the rotor body 406. In this regard, eddy current sensors 414 located at a first point 4i output a signal with a different amplitude to eddy current sensors located at a second point 4ii which output a signal with a different amplitude to eddy current sensors located at a third point 4iii. As the combination of respective amplitudes will be unique at any given position, depending on the amplitude of the signal output by the eddy current sensors 414, the absolute position of the rotor body 406 with respect to the stator to which the eddy current sensors 414 are attached may be determined.

As with the axial encoder of FIG. 3, it is possible to make such absolute position determinations using a single eddy current sensor 414 and a processor which is configured to interpret, from the eddy current sensor's signal, the absolute position of the sensor 414. Of course, for such an arrangement to work, the spiral groove 415 must be configured such that the amplitude of the signal output by the eddy current sensor 414 is unique for every position that the single sensor 414 may take around the rotor body 406. However, as with the above, in some embodiments the axial resolver 400 comprises a plurality of eddy current sensors 414. By having two eddy current sensors 414 side-by-side, the accuracy of the determined position of the groove 415 with respect to the outer diameter 408 and the inner diameter 407 increases and, therefore, the accuracy of the axial resolver 400 is increased. Further, by arranging multiple eddy current sensors 414 at different points 4i, 4ii, 4iii around the rotor body 406, it is possible to crosscheck the output of each sensor 414 against the others.

As with the axial encoder 300 of FIG. 3, in some embodiments the sensors 415 are arranged such that one of them is always detecting a steep portion (between a peak and a trough) of the sinusoidal eddy current signal. In this manner, this embodiment comprises six eddy current sensors 415 located in three pairs around the circumference of the rotor body 406. As with the encoder 300 of FIG. 3, the pairs of sensors 414 may be positioned evenly around the circumference of the rotor body 406, as long as the number of magnets 413 is not divisible by the number of circumferential positions of the sensors 414. Alternatively, the number of magnets 413 can be divisible by the number of circumferential positions of the sensors 414, as long as the sensors 414 are not positioned evenly around the circumference of the rotor body 406.

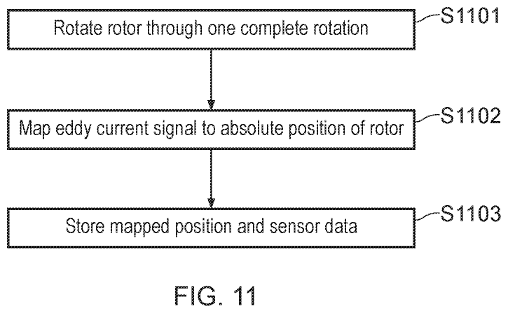

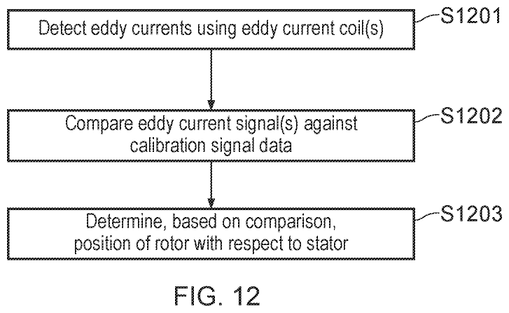

In order to ensure that a processor is capable of determining an absolute position of the rotor body 406 with respect to the stator, once the axial resolver 400 has been formed, it is necessary to perform a step of calibrating the resolver 400. In this manner, the rotor body 406 performs one complete rotation, such that each of the eddy current sensors 414 has detected an eddy current signal corresponding to each point around the full circumference of the rotor body 406. Then, by assigning a first absolute position 4i to a first particular output, a second absolute position 4ii to a second particular output, a third absolute position 4iii to a third particular output, as well as all of the positions and outputs in between, the processor is then able to determine any absolute position in accordance with the output received from the eddy current sensors 414. The process of calibration and operation will be described in more detail below with respect to FIGS. 11 and 12.

Of course, as the embodiment of FIG. 4 comprises 3 pairs of sensors, the processor will receive signals relating to three different absolute positions at any given time. These three signals are crosschecked to ensure that they agree with each other and, therefore, provide an accurate output of the absolute position of the rotor body 406 with respect to the stator.

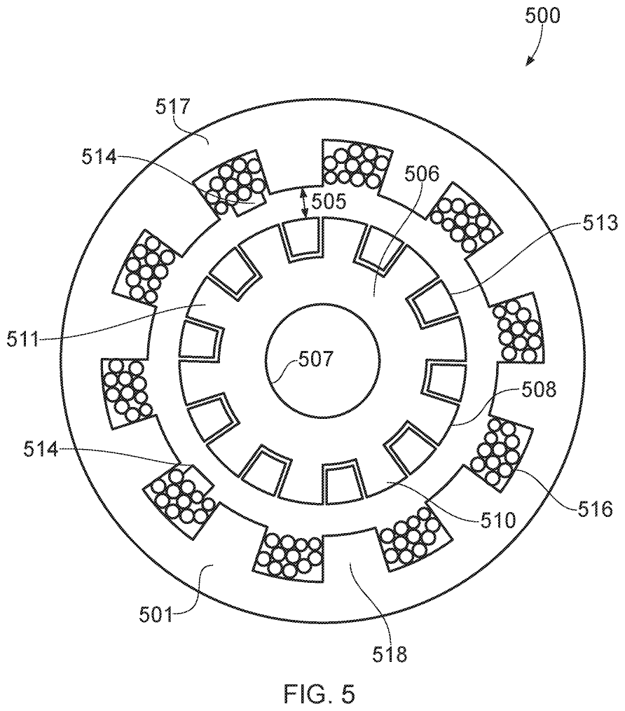

With reference to FIG. 5, there is described certain parts of an electric machine, including a radial encoder 500, in accordance with the present disclosure. The radial encoder 500 of FIG. 5 has all of the same features as the axial encoder 300 of FIG. 3, except the relative positioning of the rotor and the stator. In this manner the electric machine shown in FIG. 5 includes a rotor 510 and a stator 501. The stator 501 is located radially outside of the rotor 510. The stator 501 comprises a stator body 517 which forms a plurality of stator posts 518. A plurality of windings, or coils 516, are wound around the stator posts 518. The rotor 510 comprises a rotor body 506 which comprises a plurality of magnet-retaining rotor slots 512. A plurality of magnets are located within respective rotor slots 512. The rotor slots 512 and, hence, the magnets 513, are evenly spaced around the circumference of the rotor body 506. Rotor posts 511 are positioned between each rotor slot 512. The rotor posts 511, rotor slots 512 and the magnets 513 extend between an inner diameter 507 and an outer diameter 508 of the rotor body 506. The electromagnets formed by the windings 516 and the stator posts 518 of the stator 501 and the permanently magnetic rotor posts 511 formed using the magnets 513 of the rotor 510 cause the rotor 510 and the stator 501 to be magnetically coupled.

The radial encoder 500 of FIG. 5 comprises a plurality of eddy current sensors 514. The eddy current sensors 514 are attached to the stator 501 of the electric machine. The eddy current sensors 514 are configured to detect the rotor body 506 by inducing eddy currents within it. In this manner, as the rotor 510 rotates with respect to the stator 501, the magnets 513 and the rotor posts 511 move past the eddy current sensors 514. As such, the distances between the rotor body 506 and the eddy current sensors 514 varies over time. As above, this can be considered to be a detectable feature of the rotor body 506. Due to the manner in which the magnets 513 and the rotor posts 511 are positioned around the rotor body 506, the eddy currents detected by each eddy current sensor 514 results in a sinusoidal output, as the rotor is rotated with respect to the stator. In this regard, when a rotor post 511 is aligned with an eddy current sensor 514, the eddy current sensor output is at a maximum. Similarly, when a magnet 513 is aligned with the eddy current sensor 514, the eddy current sensor output is at a minimum. This is because eddy currents are generated in the steel of the rotor posts 511.

As described with reference to FIG. 1, the electric machine shown in FIG. 5 is arranged such that there is a small airgap 505 between the rotor 510 and the stator 501. This ensures a high degree of magnetic coupling between the rotor 510 and the stator 501 and, therefore, a high torque output. In light of this, it is necessary to position the eddy current sensors 514 on the windings, or coils 516, of the stator 501.

As discussed in relation to FIG. 3, by coupling the eddy current sensors 514 to a processor, it is possible to determine relative motion between the rotor 510 and the stator 501 by monitoring the sinusoidal variations in the eddy currents detected by the eddy current sensors 514 as the rotor 510 rotates within the stator 501.

FIG. 5 shows that the radial encoder 500 comprises a stator 501 with 14 stator posts 518 and a rotor with 13 rotor posts 511. Further, the stator 501 further comprises two eddy current sensors 514, arranged to induce eddy currents in the rotor body 506. However, as with the above, it should be understood that the radial encoder 500 may comprise any number of sensors 514. For example, the radial encoder 500 may comprise one, two, three, four, five or more sensors 514. If using only one sensor 514, it is possible to monitor variations in eddy currents, as set out above, and determine movement, speed of rotation, and the number of turns of the rotor. However, by using more than one sensor 514, a more accurate determination of the relative motion of the rotor 510 and the stator 501 may be made, as described below. Therefore, in some embodiments, one may use multiple sensors 314.

As set out above with reference to the axial encoder 300 and the axial resolver 400, in some embodiments the eddy current sensors 514 and the magnets 513 are arranged such that at least one sensor 514 is detecting a steeper portion of the sinusoidal eddy current wave at any point in time while the rotor 510 is rotating. This can be achieved by carefully choosing the number and position of the sensors 514 as well as the number of magnets 513, as discussed above with reference to the axial encoder of FIG. 3. In essence, by using two or more sensors, it is possible to ensure that at least one of the sensors is always producing an output which is on a stepper part of the sinusoidal wave slope. This increases the resolution that is achievable by the sensor.

As described above with respect to the encoder of FIG. 3, it should be further noted that, using the relative position information determined by the eddy current sensors 514, it is also possible to determine an absolute position of the rotor body 510 with respect to the stator 501. In order to achieve this, a processor which is receiving the eddy current signals and, thus, determining the relative position information further requires position information regarding an original orientation of the rotor body 306 with respect to the stator. With this information, it is therefore possible to apply the relative position information to the initial absolute position information to determine a present absolute position. For example, the processor may determine that the rotor 510 has moved by 120° with respect to the stator 501. The processor may then refer to a memory which stores the initial, absolute position information. If the memory has stored that the rotor was initially located at a position which is 10° offset from the stator 501, then the processor is able to determine that an absolute position of the rotor 510 with respect to the stator 501 is 130° from an absolute starting point of 0°.

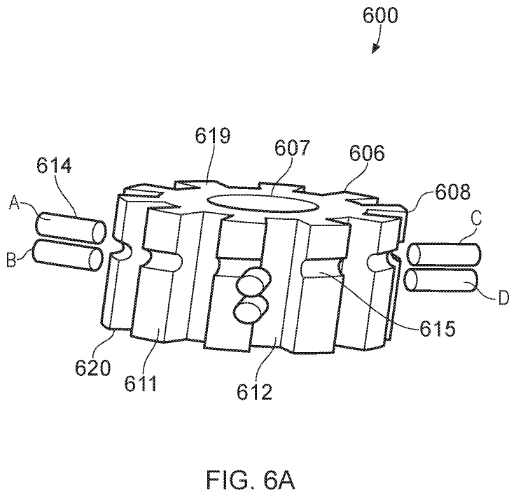

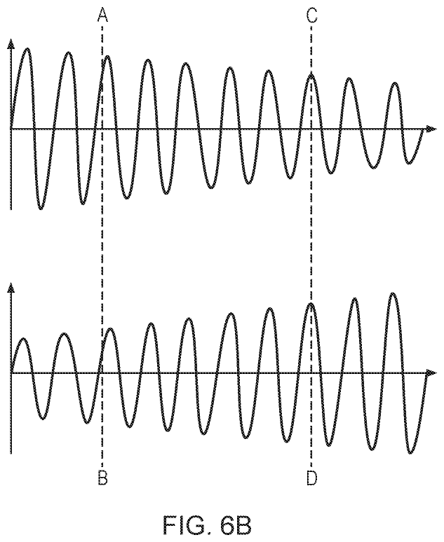

With reference to FIGS. 6A and 6B, there is shown a perspective view of certain parts of a radial electric machine, including a radial resolver 600, in accordance with the present disclosure. The radial resolver 600 of FIG. 6 has all of the same features as the axial resolver 400 of FIG. 4, except the relative positioning of the rotor and the stator. In this manner, the electric machine comprises a rotor body 606, which forms part of a rotor, and a stator (not shown). The stator is located radially outside of the rotor body 606, in a similar manner to the electric machine in FIG. 5. The electric machine shown in FIG. 6 includes the rotor body 606 which comprises a plurality of magnet-retaining rotor slots 612. A plurality of magnets 613 are located within respective rotor slots 612. The rotor slots 612 and, therefore, the magnets 613, are evenly spaced around the circumference of the rotor body 606. Rotor posts 611 are formed between the rotor slots 612. The rotor posts 611, rotor slots 612 and the magnets extend between an inner diameter 607 and an outer diameter 608 of the rotor body 606. Further, the radial resolver 600 also comprises a plurality of eddy current sensors 614, which are attached to the stator. As with the radial encoder 500, the radial resolver 600 may comprise any number of eddy currents sensors 614, including one, two, three, four, five, six or more sensors 614. However, higher numbers of sensors 614 may be used in some embodiments in order to provide for a higher ‘resolution’ of determined position.

In contrast to the radial encoder 500 of FIG. 5, and in a similar manner to the axial resolver 400 of FIG. 4, the radial resolver 600 of FIG. 6 further comprises a groove 615 which is formed into a circumferential surface of the rotor body 606. The groove 615 is formed such that, at one end, the groove 615 is formed adjacent a first surface 619 of the rotor body 406 and, at the other end, such that it is adjacent a second surface of the rotor body 606. In this manner, the groove 615 forms a type of spiral which extends from the first surface 619 to the second surface 620 as it curves around the outer diameter 608 of the rotor body 606. The groove 615 is, importantly, only formed in the rotor body 606 itself, and the magnets do not include the groove 615. This ensures that the radial resolver 600 does not act to reduce the magnetic coupling between the rotor and the stator of the electric machine to which it is a part. In combination with the alternating nature of the rotor posts 611 and the magnets 613, the groove is a further detectable feature, which acts to make the alternating eddy current signal unique, in terms of its amplitude, at any given point around the circumferential extend of the rotor body 606.

When an eddy current sensor is aligned with a rotor post 611, the sensor signal strength will be lower when radially aligned with the groove 615. This is because the material of the post is positioned further away from the sensor, thereby causing the sensor to produce a weaker signal. As such, an amplitude of the signal output by the eddy current sensors 614 varies in comparison to an equivalent signal from an eddy current sensor 514 of the radial encoder 500 of FIG. 5, depending on whether or not the sensor 614 is aligned with the groove 615. Due to the spiral nature of the groove 615, the signal output by eddy current sensors 614 at the same axial position will vary in amplitude around the circumference of the rotor body 606. In this regard, a first eddy current sensor A located at a first point will output a signal with a different amplitude to a third eddy current sensor C located at a second circumferential point but in the same axial plane. Similarly, a second eddy current sensor B located at the first point but in a different axial plane to the first eddy current sensor A will output a signal with a different amplitude to a fourth eddy current sensor D located at the second circumferential point but in the same axial plane as the second eddy current sensor B. As the combination of respective amplitudes will be unique at any given position, depending on the amplitude of the signal output by the eddy current sensors A, B, C, D, the absolute position of the rotor body 606 with respect to the stator to which the eddy current sensors 614 are attached may be determined.

FIG. 6B shows the eddy current signals output by the eddy current sensors 614 of the radial resolver of FIG. 6A. As described above, the signal output by the eddy current sensors 614 is sinusoidal in shape as a result of the repeating structure of the magnets and rotor posts 611 across the outer diameter 608 of rotor. Further, due to the formation of the spiral groove 615 around the outer diameter 608 of the rotor body 606, the amplitude of the eddy current signal varies based on the proximity of the groove 615 to the respective sensor 614. With the spiral groove 615 being arranged to extend between the first surface 619 and the second surface 620 of the rotor body 606, the amplitude of the eddy current signal changes from a maximum amplitude to a minimum amplitude, or vice versa, depending on the specific orientation of the spiral groove 615 and its locality to each sensor 614. In this manner, as shown in FIG. 6B, the amplitude of the signal output by the first eddy current sensor A is at a higher amplitude than the signal being output by the second eddy current sensor B and the third eddy current sensor C. This is because the groove 615 is adjacent the second eddy current sensor B and the third eddy current sensor C. As will be understood, as the rotor body 606 rotates (in this example, in a clockwise manner), the signal output by the first eddy current sensor A will follow the upper waveform as the groove 615 moves closer to the first eddy current sensor A, thus decreasing the amplitude of the output signal. In this regard, due to the similar axial positions of the first eddy current sensor A and the third eddy current sensor C, the waveform output by those two sensors will be alike. Similarly, the waveform of the signals output by the second eddy current sensor B and the fourth eddy current sensor D will be alike, due to their matching axial positioning. As set out above, the radial difference in their positioning causes them to output different positions and phases of the waveform at similar times.

Although only one of these sensors 614 is required to determine an absolute position of the rotor body 606 with respect to the stator, by using the signals output by all four sensors, a higher accuracy of the absolute position may be determined.

In order, for an arrangement comprising a single eddy current sensor 614 to work, the spiral groove 615 must be configured such that the amplitude of the signal output by the eddy current sensor 614 is unique for every position that the single sensor 614 may take around the rotor body 606. This can be achieved by ensuring that the spiral groove 615 never crosses the axial plane in which the eddy current sensor 614 lies, thereby not introducing a mirroring of the amplitude of the eddy current waveform.

By having two eddy current sensors A, B side-by-side (i.e., in the same radial plane), the accuracy of the determined position of the groove 615 with respect to the first surface 619 and the second surface 620 increases and, therefore, the accuracy of the radial resolver 600 is increased. This is, in part, because the combined signal output by the first eddy current sensor A and the second eddy current sensor B is unique for all portions of the waveform, even if the spiral groove 615 is arranged to cross the same axial plane as one or both of the sensors A, B.

Further, by arranging multiple eddy current sensors 614 at different radial points around the rotor body 606, it is possible to crosscheck the output of each sensor 414 against the others and, as described above, ensure that at least one sensor is detecting a steep part of the waveform at any given instance.

In this manner, one embodiment comprises six eddy current sensors 615 located in three pairs around the circumference of the rotor body 606. As with the axial encoder 300 of FIG. 3, the pairs of sensors 614 may be positioned evenly around the circumference of the rotor body 606, as long as the number of magnets 613 is not divisible by the number of circumferential positions of the sensors 614, thus avoiding all of the sensors 614 being in phase with each other. Alternatively, the number of magnets 613 can be divisible by the number of circumferential positions of the sensors 614, as long as the sensors 614 are not positioned evenly around the circumference of the rotor body 606, again, avoiding the sensors 614 being in phase with each other.

As with the axial resolver of FIG. 4, in order to ensure that a processor is capable of determining an absolute position of the rotor body 606 with respect to the stator, once the radial resolver 600 has been formed, it is necessary to perform a step of calibrating the resolver 600. In this manner, the rotor body 606 performs one complete rotation, such that each of the eddy current sensors 614 has detected an eddy current signal corresponding to each point around the full circumference of the rotor body 606, this forms the waveforms shown in FIG. 6B. Then, by assigning absolute positions to each of the parts of the waveform for each sensor 614, the processor is then able to determine any absolute position in accordance with the output received from the eddy current sensors 614. The process of calibration and operation will be described in more detail below with respect to FIGS. 11 and 12.

Of course, as the embodiment of FIG. 6 comprises 3 pairs of sensors 614, the processor will receive signals relating to three different absolute positions at any given time. These three signals are crosschecked to ensure that they agree with each other and, therefore, provide an accurate output of the absolute position of the rotor body 606 with respect to the stator. This is described in more detail below.

The above axial and radial encoders and resolvers of FIGS. 3 to 6 are arranged such that they are capable of being retroactively installed in legacy electric machines. In this manner, a prior art radial or an axial electric machine (such as those shown in FIGS. 1 and 2) can be disassembled, installed with one or more eddy current sensors and, if forming a resolver, a groove and then reassembled. Of course, the eddy current sensors and/or the groove can be introduced during initial production of the electric machine. For example, the groove can be formed as part of a casting process, if the rotor body is formed by casting. As another example, the groove can be machined into a surface of the rotor body, before or after the magnets are installed within the rotor body.

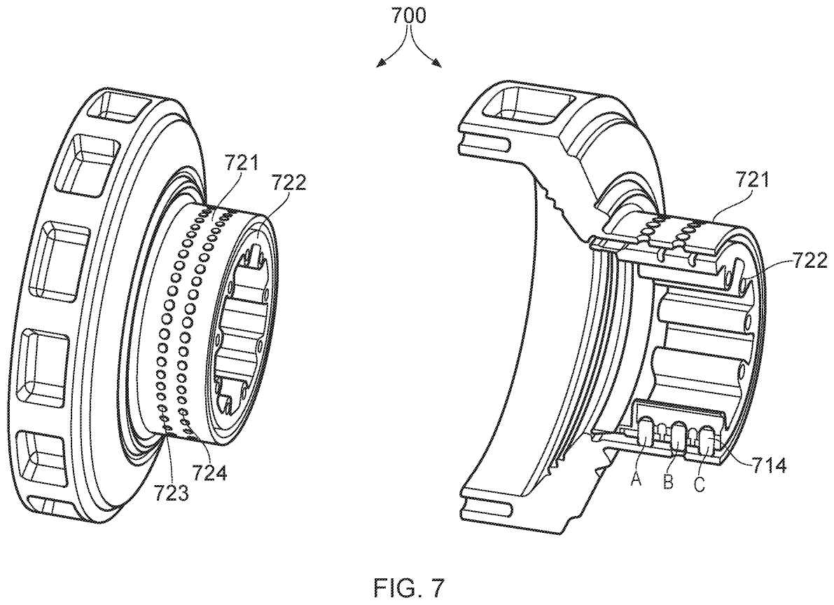

However, forming encoders and resolvers in this manner does not make the most efficient use of space within an electric machine. As such, with reference to FIG. 7, there is described a resolver 700 comprising a structure which makes a more efficient use of space for including the resolving features.

As with the above, the electric machine comprises a rotor and a stator, however, for the sake of clarity in defining the important features of the resolver 700, several features of the rotor and the stator are not shown in FIG. 7. It is to be understood that the electric machine does include these features, as per the above. FIG. 7 does depict an output member 721 which is arranged to form a part of the rotor of the electric machine and a fixed member 722 which is arranged to form a part of the stator. The output member 721 and the fixed member 722 are formed as concentric shafts which extend from the rotor and the stator respectively. As with the encoders and resolvers described above, the resolver 700 of FIG. 7 also includes a plurality of eddy current sensors 714 which are attached to the fixed member 722.

In contrast to that which has been described above, the eddy current sensors 714 of the resolver 700 of FIG. 7 are not arranged to detect changes in the eddy current in a rotor body directly. Instead, the eddy current sensors 714 are arranged to detect the eddy current in the output member 721 attached to the rotor body. As the output member 721 does not comprise any magnets, the eddy currents within the output member 721 would be expected to be largely constant across its structure. Therefore, in order to enable to resolver 700 to determine an absolute position of the rotor with respect to the stator, the resolver also includes a first plurality of holes 723 and a second plurality of holes 724 formed within the output member 721.

The first plurality of holes 723 and the second plurality of holes 724 are arranged as a set of adjacent holes of similar size and shape which extend around the circumference of the output member 721. A first eddy current sensor A is arranged to line up with the first plurality of holes 723 such that, in use, the first eddy current sensor A outputs a sinusoidal waveform as it detects a hole and the material between each hole consecutively. Similarly, a second eddy current sensor B is arranged to line up with the second plurality of holes 724 such that, in use, the second eddy current sensor B outputs a sinusoidal waveform as it detects a hole and the material between each hole respectively. In this manner, instead of the alternating nature of the rotor posts, magnets and grooves described above, the holes 723, 724 act to form the detectable feature which is detected by the eddy current sensors 714.

Of course, in using just one eddy current sensor 714 and one plurality of holes 723, the sinusoidal wave produced would enable the device to be used as an encoder, in that it is possible to determine relative movement between the rotor and the stator as set out above. However, by using a first and second plurality of holes 723, 724 it is possible to use the device as a resolver 700 to determine an absolute position of the rotor with respect to the stator. The important feature for forming the device as a resolver 700 is that the total number of holes constituting the first plurality of holes 723 should be mutually prime with respect to the number of holes constituting the second plurality of holes 724. In other words, the total number of holes forming the first plurality of holes 723 should have no factors in common with the number of holes forming the second plurality of holes 724, except for the number 1. For example, the resolver 700 of FIG. 7 is arranged such that the first plurality of holes 723 comprises 52 holes in total and the second plurality of holes 724 comprises 53 holes in total. The only factor in common between 52 and 53 is the number 1.

In forming the first and second plurality of holes 723, 724 such that they are mutually prime, the complete sinusoidal waveforms produced by the first and second eddy currents sensors A, B will have different wavelengths which are in phase with each other only once across their entire waveform. For example, using the resolver 700 of FIG. 7, each time the first eddy current sensor A outputs a peak in signal, the second eddy current sensor will output, at the same time, a signal which has a phase shifted by 1/52 of a complete wavelength of the output of the second eddy current sensor B. Therefore, by monitoring the signal output by both the first and second eddy current sensors A, B, at a processor, it is possible to determine an absolute position of the rotor with respect to the stator.

The resolver 700 of FIG. 7 also comprises a third eddy current sensor C which is not aligned with a plurality of holes. Instead, the third eddy current sensor C is aligned with a portion of the output member 721 which is devoid of features. In this manner, the third eddy current sensor C acts as a calibration sensor C. The calibration sensor C provides a base signal against which the processor can normalise the signals output by the first eddy current sensor A and the second eddy current sensor B. This enables the processor to account for manufacturing defects and anomalies introduced environmental factors such as temperature. The calibration sensor C should be in line with both of the first and second eddy current sensors A, B. If the first and second eddy current sensors A, B are not radially aligned, each eddy current sensor A, B should have a corresponding calibration sensor C which is radially aligned with the respective eddy current sensor A, B. The processor may then act to normalise the output signals from the first and second eddy current sensors A, B individually using their respective calibration sensors C.

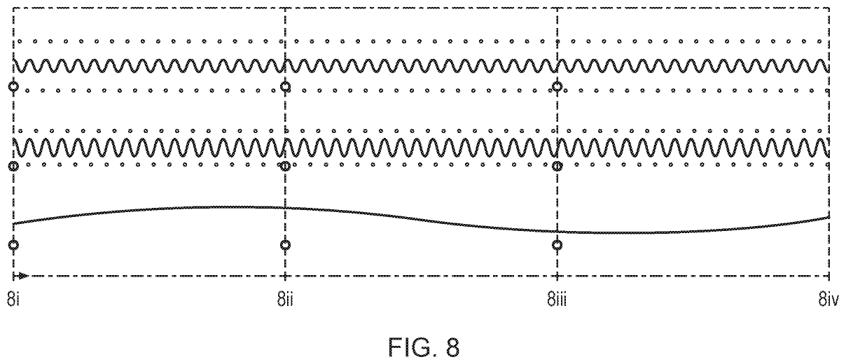

With reference to FIG. 8, there is shown an example set of waveforms for the three eddy currents sensors A, B, C of the resolver 700 of FIG. 7. As can be seen in FIG. 8, the uppermost waveform comprises 53 complete waves. This waveform is the output of the second eddy current sensor B of the resolver 700. The middle waveform comprises 52 complete wave and is the output of the first eddy current sensor A of the resolver 700. The lowermost waveform is the output of the third eddy current sensor C and does not necessarily comprise a complete wave. Instead, the lowermost waveform contains only the noise which should be removed from the waveforms of the outputs of the first and second eddy currents sensors A, B.

As can be seen in FIG. 8, at a first point 8i in the waveforms, the signals output by the first and second eddy current sensors A, B are in phase. In contrast, at a second point 8ii in the waveforms, the signals are clearly out of phase. Similarly, at a third point 8ii of the waveform, the signals have moved beyond being 180° out of phase. Finally, by a fourth point 8iv of the waveform, the two signals are nearly completely back in phase. This series of positions represents the points around the circumference of the output member 721 and, by monitoring the phase of the two waves, it is possible to determine an absolute position of the rotor with respect to the stator.

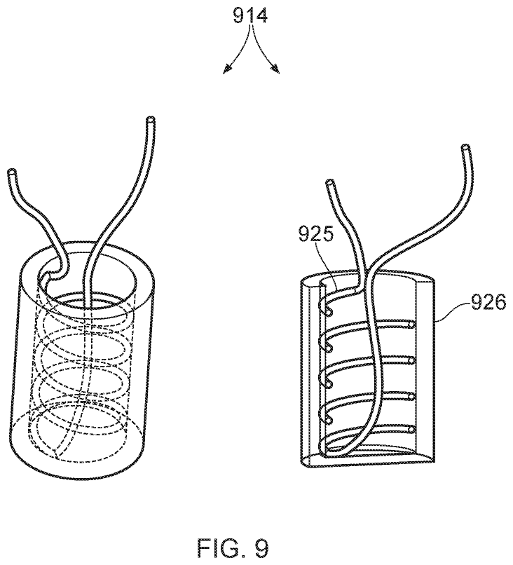

With reference to FIG. 9, there is shown an eddy current sensor 914 for use with the encoders and resolvers of the present disclosure. The eddy current sensor 914 comprises an eddy current coil 925 which is arranged to detect the proximity of eddy currents in nearby materials. In order that the eddy current coil 925 maintains its shape a housing 926 is located around the coil 925. The housing 926 may be formed from any structurally suitable non-magnetic material, such as a plastic. In some embodiments, the housing 926 is formed from polyether ether ketone (PEEK). In order to further ensure that the eddy current coil 925 does not change shape, once the coil 925 has been located within the housing 926, the housing 926 is backfilled. For example, the housing 926 may be backfilled with a thermosetting plastic. In some embodiments, the housing 926 is backfilled with PEEK. The eddy current coil 925 is electrically connected to an output, which transfers signals generated by the eddy current sensor 914 to the processor.

It is to be understood that, in the context of the present disclosure, the eddy current sensors 914 are being utilised for their ability to detect the proximity of steel by inducing and detecting eddy currents in the rotor posts. In this manner, the signal output by the eddy current sensors 914 can be seen as a relative determination as to the proximity of an eddy current and, therefore, a rotor post (in the context of FIGS. 3 to 6) or the output member (in the context of FIG. 7). In light of this, it should be further understood that it is not a requirement of the present disclosure that eddy current sensors 914 are used to determine the relative or absolute position of the rotor with respect to the stator. It is clearly possible to use other forms of detectable feature and other forms of proximity sensor in order to determine relative or absolute position. For example, the encoder may comprise a magnetometer, an infrared sensor or any other kind of proximity sensor in order to monitor a repeating feature of the rotor. Further, the resolver may comprise any kind of detectable feature which, in combination with the proximity sensor, causes the proximity sensor to output a unique signal for each position of the rotor with respect to the stator. For example, the detectable feature may have a unique shape or size at a plurality of positions.

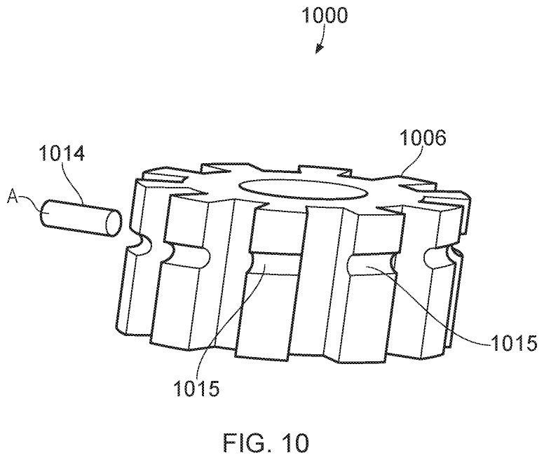

With reference to FIG. 10, there is shown a radial resolver 1000 with substantially the same features as the radial resolver 600 of FIG. 6. However, the radial resolver 1000 of FIG. 10 differs from that of FIG. 6 in that it comprises only a single eddy current sensor 1014. As described above, the present disclosure is capable of determining the absolute position of a rotor body 1006 with respect to a stator if the groove 1015 is arranged such that the eddy current sensor 1014 outputs a unique signal for each position of the groove 1015 with respect to the circumference of the rotor body 1006. In essence, as long as the output signal of the eddy current sensor 1014 is not caused to mirror due to the groove 1015 crossing the same axial plane as the eddy current sensor 1014, then the eddy current sensor 1014 is able to about a unique signal for each position of the rotor body 1006. Of course, the radial resolver 1000 of FIG. 10 could, instead, be used as a radial encoder, as set out above, with the omission of the groove 1015.

With reference to FIG. 11, there is described a method of calibrating a resolver according to the present disclosure. At step 1101, the rotor of the electric is rotated through one complete rotation. This can be performed at a constant speed, or at a variable speed. It is simply important that the processor is provided with details of the speed of rotation during the calibration phase. During this step, each eddy current sensor outputs a signal which varies as each rotor post and rotor magnet rotate past each sensor. The processor receives the signals from the eddy current sensors. At step S1102, the processor, using the speed of rotation information, maps the signals received from the eddy current sensors onto the information regarding the absolute position of the rotor at the time the signal was received. For example, if the rotor is rotating at one degree per second, then the processor can record an output value from the eddy current sensors each second and assign that value to the appropriate angle of rotation. This can be performed for each angle such that the processor has mapped 360 unique output values against each full degree of rotation. As such, for any given signal information, the processor has a lookup containing a corresponding absolute position. Finally, at step S1103, the processor stores the mapped data in a table in a memory, for reference when receiving future eddy current signal data. An example of a portion of a table containing these mapped values is shown below for an embodiment comprising a single eddy current sensor.

| Output (V) | Angle (°) |
|---|---|
| 5.0 | 0 |
| 4.9 | 1 |
| 4.8 | 2 |
| 4.7 | 3 |
| 4.6 | 4 |

Of course, in embodiments wherein the resolver comprises more than one eddy current sensor, the table is expanded to include an output value column for each eddy current sensor, as the individual output values for each sensor may vary slightly for any given rotor angle.

Further, although the above embodiment describes that an eddy current senor is recorded every one degree of rotation of the rotor, this is merely an example. Depending on the accuracy of the eddy current sensors and the specific requirements, it may be necessary to record a value of the eddy current senor outputs more or less frequently.

With reference to FIG. 12, there is described a method of determining an absolute position of a rotor with respect to a stator in accordance with the present disclosure. At step S1201, during use of the electric machine, the eddy current sensors output an eddy current signal which corresponds to the rotation of the rotor and the consequential sinusoidal waveform of decreasing/increasing amplitude as described above. The eddy current sensor output signal is received at the processor. In step S1202, the processor compares the received eddy current signal with a stored signal for the sensor from which the signal was received. As described above with reference to FIG. 11, the stored signal is that which is stored as a result of the calibration step, wherein the eddy current output signals are mapped against an absolute angular position of the rotor. At step S1203, the processor determines, based on the comparison, the absolute position of the rotor with respect to the stator. This is achieved by using a simple lookup wherein the received output signal is compared against a list of output values from the stored table. This returns an absolute angular position value for the processor to output. An example of such a lookup is shown below.

| Received Output (V) | Stored Output (V) | Stored Angle (°) |
|---|---|---|
| | 5.0 | 0 |
| | 4.9 | 1 |
| 4.8 | 4.8 | 2 |
| | 4.7 | 3 |
| | 4.6 | 4 |

As discussed above for the calibration table, if the resolver comprises multiple eddy current sensors, each eddy current sensor will have a separate column in the lookup table. Therein, the processor can compare each of the received outputs simultaneously, to check that they each agree regarding the position of the rotor, from their specific angle. For example, in an embodiment wherein three sensors are located 120° apart, if the lookup performed by the processor returns three stored angles of 10°, 130° and 250°, each of the eddy current sensors can be assumed to be returning a correct value and the position of the rotor can be output with a high level of accuracy.

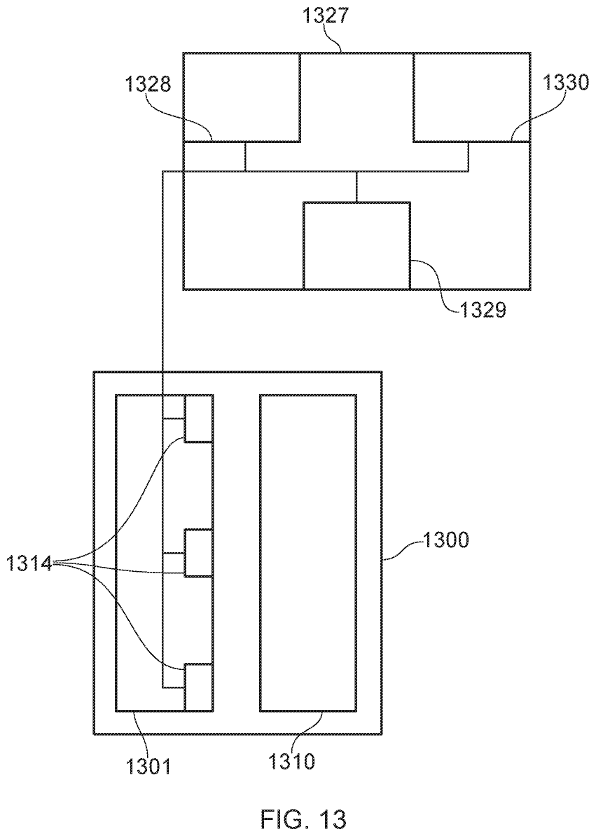

With reference to FIG. 13, there is shown a schematic of an encoder or resolver system according to the present disclosure. The encoder/resolver 1300 comprises a stator 1301 and a rotor 1310, as described above. Further, the stator 1301 comprises a plurality of eddy current sensors 1314 arranged to detect eddy currents in the rotor 1310. Each of the eddy current sensors 1314 is connected to a computer 1327, either by wired or wireless means. Specifically, the eddy current sensors 1314 are connected to a processor 1328 which is arranged to perform the necessary calculations to determine the relative and/or absolute position of the rotor 1310 with respect to the stator 1301. The processor 1328 is further connected to a memory 1329, which is arranged to store the calibration data relating to the absolute position of the rotor and enable access by the processor to such data for determination of the position of the rotor. The computer 1327 further comprises a user interface 1330, at which the rotor position can be output by the processor 1328.

In a further embodiment, the encoder or resolver of the present disclosure may be used to form a torque sensor. Specifically, the disclosure may be used to form a phase shift torque sensor. In this regard, in order to form a torque sensor, first and second encoders are located, within an electric machine, adjacent to an input shaft and an output shaft respectively. As described above, the first and/or second encoders may comprise one or more eddy current sensors, attached to the stator, arranged to output a sinusoidal signal as the rotor rotates with respect to the stator. Alternatively, the first and/or second encoders may be attached to the rotor and to output a sinusoidal signal as the stator rotates with respect to the rotor. The sinusoidal output may be achieved using one or more of: the rotor posts and rotor slots; the stator posts and stator coils; and the rows of holes, as described above. In one embodiment, similar to the resolver of FIG. 7, the torque sensor may comprise a first row of holes in the input shaft, from which a first encoder can output a first sinusoidal signal and a second row of holes in the output shaft, from which a second encoder can output a second sinusoidal signal.

With the two encoders installed within the electric machine, a calibration step can be used to determine the first and second sinusoidal outputs of the first and second encoders under zero or minimal torque. The first and second sinusoidal outputs can then be aligned, such that they are considered to be in phase with each other at zero torque. During use, at low torque, the first and second sinusoidal outputs will remain substantially in phase with each other, as the electric machine components will undergo no deformation. However, at high rotational speeds of the electric machine, the first and second sinusoidal outputs from the first and second encoders will move out of phase with each other. This shift in phase between the two outputs is indicative of the torque being applied to the rotor. Thus, it is possible to determine a torque across an electric machine by locating encoders at opposing ends of the electric machine, i.e., near the input and output shafts. Of course, in order to determine the specific torque value, Young's modulus calculations for the stiffness of the material will need to be used to calculate the load or torque through the electric machine. However, achieving this will be known to the skilled person in phase shift torque measurement.

Embodiments of the present disclosure comprise a design geometry that is equally applicable to electric machines of any size such as, for example, small motors for use in robotics environments or very large generators for use in domestic electricity generation. In one embodiment, the rotor body 211 has an outer diameter of between 200 mm and 300 mm. In an embodiment, the rotor body 211 has an outer diameter of 250 mm.

Further, embodiments of the present disclosure discuss the device in terms of a rotor located radially inside a stator, such that the outer circumference of the rotor is adjacent to an airgap between the rotor and the stator. However, it is to be understood that this is merely exemplary and that, equally, the rotor may be radially outside of the stator, such that the airgap is located adjacent to the inner diameter. For an outer rotor, features which are defined above with reference to the outer diameter will instead relate to the inner diameter and features which are defined with reference to the inner diameter will instead relate to the outer diameter.

It should also be noted that the drawings referenced above are schematic in nature, and should not be taken to convey the specific dimensions or characteristics of an electric machine, encoder or resolver according to the present disclosure. For example, with reference to FIG. 3, the air gap 505 is depicted as being much larger than would typically be expected in an electric machine. This has been done in order to aid understanding the important features of the present disclosure. Similarly, as set out above, the several figures, the stator of the electric machine is not shown. This has been done in order to improve the clarity of the figures with respect to the important features of the present disclosure. It is to be understood that the electric machine includes a stator.

### ANNEX

### Integrated Encoder Description

One or more features positioned on a rotating or translating surface of an actuator such as a magnetic rotor to be interfaced with one or more proximity sensors positioned on a fixed surface of the actuator such as a stator. The geometry of the feature is such that a localized portion of the feature exposed to the proximity sensor is itself unique or has a unique position relative to the proximity sensor. The unique portion or position exposed to the proximity sensor consequently reads and recognizes a unique position of the rotating or translating portion of the actuator relative to the fixed portion of the actuator.

Embodiments of the feature consist of an embossed metallic spiraled strip as shown in FIG. 2 on the base of a representative rotor. Three pairs of proximity sensors in the form of induction coils are equally spaced on a circumference on a fixed surface of a representative stator in locations under the strip. The proximity sensors return a different strength of signal depending on their location relative to a metallic feature. Because the radius of the strip changes along a circumference on the rotor and is unique at a specific radial location, the sensors can deduce a radial position based on the equivalent measured radius of the feature.

### Alternate Explanation.

Eddy current proximity sensors are common to motion control and other industries. They consist of a small electrically conductive coil that is energized at a higher frequency of alternating current. This changing electromagnetic field will produce eddy currents in any conductive material in close proximity.

The production of these eddy currents will change the characteristics of the coil such that the proximity of the coil to the conductive target can be sensed.

On a high pole count electric motor with amplified magnetics, as shown in FIG. 5, the steel posts and the permanent magnets between them will have different eddy current characteristics which can be detected by an eddy current sensor such as a coil which is powered at high frequency. If this frequency is significantly higher than the frequency of the motor control, the sensor will be unaffected by any magnetic fields in the motor.

By positioning one eddy current sensor on the top of one of the slots as shown in FIG. 5 below, the difference in the eddy response of the steel poles and PM's between the magnets can be measured and an incremental encoder is created which can count the number of steel poles which pass by it. To be clear, the eddy current coil is not measuring the magnetic field, it is creating eddy currents in the steel and in the magnets. The magnetic will have a different conductivity (much lower for rare earth magnets, typically) so the eddy current sensor will provide some sort of sine wave signal to the encoder electronics CPU as the rotor poles move past it.

In FIG. 6, an embodiment shows multiple eddy current coils which will all read a slightly different part of the generally sinusoidal signal as the rotor poles pass them. This is due to the different number of stator and rotor poles which means the eddy current sensors will be spaced differently than the rotor poles. In one embodiment, three eddy current coils are arrayed around the stator and positioned such that each of the eddy current coils will register at a different part of the sine wave. In this way, at least one of the eddy coils will be on a steep section of at least one of the sine wave signals at all times. In this position, for example, eddy coil A is at a low slope position where high position resolution is difficult. Sensors B and C, however, are on steeper sections of the sine wave where higher resolution is possible. As a result, the eddy sensors will provide both an incremental encoder signal as well as a proportional signal more like an absolute encoder response or resolution.

In FIG. 7, a schematic of an absolute encoder is shown. In this configuration, there are three sets of two or three eddy coils arrayed around the stator. Each of the rotor poles has a spiral slot which changes the volume of material around a particular eddy coil that it is close to. When an eddy coil is aligned with a rotor pole where there is no spiral slot, the eddy current sensor will register a larger signal. When an eddy coil is aligned with a rotor pole near a spiral slot feature, the eddy current signal will be at a peak but lower than if there is no slot. By comparing the amplitude of preferably four or more coils in two or more positions, it is believed possible for the CPU to determine the absolute position of the rotor relative to the stator for a complete rotation of the rotor. In the FIG. 7 image, the rotor posts are shown with magnets removed (for clarity of illustration) the coils A, B, C, D are at a fixed position in the stator (stator not shown) but due to the variable position of the spiral groove, the eddy coils will register at different strengths depending on the rotational angle of the rotor and the proximity of the spiral groove.

Notice that the sine wave frequency does not change, only the amplitude. By comparing the amplitude and position of the eddy current signal from each of the coils, it will be possible for the CPU to determine the rotational position of the rotor and stator. At the same time, two or three sets of eddy coils allows the CPU to create a much higher resolution position determination between each of the eddy current sine wave peaks.

Note that the spiral slot in FIG. 7 is exaggerated and proceeds from one extreme to the other on the rotor posts at less than a complete rotor rotation. Ideally the spiral slot will change this much but over a complete 360 deg rotation (if 360 deg absolute positioning is desired.

### Features

An electric motor with an array of electromagnetic power coils. The slots for the coils contain one or more eddy current coils which detect the proximity of rotor posts.

The above where two or more eddy coils are array around the stator for higher resolution incremental position sensing

The above where a spiral slot or other varying pattern of removed material from the rotor posts results in a varying signal strength from two or more eddy coils arrayed around the stator.

1. An electric machine, comprising:
a first carrier having a detectable feature, the detectable feature having a length which extends across the first carrier;
a second carrier, positioned adjacent to the first carrier; and
one or more proximity sensors coupled to the second carrier, the one or more sensors being arranged to detect the detectable feature, wherein the detectable feature is configured to cause the one or more proximity sensors to output a signal which is unique for each position of the first carrier relative to the second carrier.

2. The electric machine of claim 1, wherein the detectable feature comprises an elongate groove located within a surface of the first carrier and wherein the one or more proximity sensors and the elongate groove are configured such that a characteristic detected by the one or more proximity sensors uniquely varies along the length of the elongate groove.

3. The electric machine of claim 2, wherein the elongate groove is a spiral shape which extends from a first surface of the first carrier to a second surface of the first carrier.

4-6. (canceled)

7. The electric machine of claim 1, wherein the characteristic is an amplitude of one or more eddy currents detected within the first carrier.

8. The electric machine of claim 7, wherein the one or more proximity sensors are eddy current sensors.

9. (canceled)

10. The electric machine of claim 1, wherein the electric machine comprises at least three proximity sensors arranged circumferentially around the second carrier.

11. The electric machine of claim 1, wherein the electric machine comprises at least six proximity sensors, arranged in axially or radially aligned pairs circumferentially around the second carrier.

12. (canceled)

13. The electric machine of claim 10, wherein the proximity sensors are attached to the second carrier at respective locations such that a respective signal output by each proximity sensor is out of phase with at least one other sensor.

14. (canceled)

15. The electric machine of claim 1, wherein the first carrier is a rotor and the second carrier is a stator.

16. The electric machine of claim 1, wherein the electric machine is an axially arranged electric machine, and wherein the detectable feature and the one or more proximity sensors are arranged on opposing faces of the first carrier and the second carrier respectively.

17. The electric machine of claim 1, wherein the electric machine is a radially arranged electric machine, and wherein the detectable feature and the one or more proximity sensors are arranged adjacent a front iron of the first carrier and a front iron of the second carrier respectively.

18-53. (canceled)

54. A position detector for an axial or radial electric machine, comprising:
one or more proximity sensors, positioned in one of a stator or rotor of an electric machine;
a detectable feature, arranged circumferentially around the other of the stator or rotor, the feature detectable by the one or more proximity sensors;
wherein the detectable feature is configured such that at each circumferential position of the rotor, with respect to the stator, the detectable feature produces a unique output in the one or more proximity detectors.

55. The position detector of claim 54, wherein the detectable feature is unique, or has a unique position, at each one of a plurality of circumferential positions.

56. The position detector of claim 54, wherein the detectable feature is a spiral groove formed in a rotor.

57. The position detector of claim 56, wherein the proximity sensors are eddy current sensors.

58. The position detector of claim 54, further comprising a processor and memory, the memory configured to store the values of the output signal of the one or more proximity sensors and corresponding positions of the rotor and stator.

59-61. (canceled)

62. An electric machine, comprising:
a first carrier having a detectable feature, the detectable feature having a length which extends across the first carrier;
a second carrier which is positioned adjacent to the first carrier; and
at least two proximity sensors coupled to the second carrier and arranged circumferentially around the first carrier, the at least two proximity sensors being arranged to detect the detectable feature and to output a signal which is unique for each of a plurality of positions along the length of the detectable feature,
wherein the first carrier comprises a plurality of magnets, and
wherein a total number of the plurality of magnets is not divisible by a total number of proximity sensors.

63. The electric machine of claim 62, wherein the electric machine comprises at least three proximity sensors arranged circumferentially around the second carrier.

64. The electric machine of claim 63, wherein the proximity sensors are attached to the second carrier at respective locations such that a respective signal output by each proximity sensor is out of phase with at least one other sensor.

65. The electric machine of claim 62, wherein the electric machine comprises at least six proximity sensors, arranged in axially or radially aligned pairs circumferentially around the second carrier.

66. The electric machine of claim 62, wherein the first carrier is a rotor and the second carrier is a stator.

67. The electric machine of claim 62, wherein the electric machine is an axially arranged electric machine, and wherein the detectable feature and the at least two proximity sensors are arranged on opposing faces of the first carrier and the second carrier respectively.

68. The electric machine of claim 62, wherein the electric machine is a radially arranged electric machine, and wherein the detectable feature and the one or more proximity sensors are arranged adjacent a front iron of the first carrier and a front iron of the second carrier respectively.
